(19) United States
(12) Patent Application Publication
(10) Pub. No.: US 2018/0062570 A1
(43) Pub. Date: Mar. 1, 2018

(54) MOUNTING STRUCTURE FOR SOLAR CELL MODULE AND MOUNTING TOOL

(71) Applicant: Yanegijutsukenkyujo Co., Ltd., Takahama-shi (JP)

(72) Inventors: Tsuyoshi MURAKAMI, Takahama-shi (JP); Takayoshi YAMANAKA, Takahama-shi (JP)

(73) Assignee: Yanegijutsukenkyujo Co., Ltd., Takahama-shi (JP)

(21) Appl. No.: 15/678,169

(22) Filed: Aug. 16, 2017

(30) Foreign Application Priority Data
Sep. 1, 2016 (JP) 2016-170476
May 26, 2017 (JP) 2017-104464

(51) Int. Cl. H02S 30/10; F16M 13/02; F16B 2/06; F24J 2/52

(52) U.S. Cl. CPC H02S 30/10; F16M 13/02; H02S 20/23; F24J 2/5205; F24J 2/5258; F16B 2/065

(57) ABSTRACT

A mounting tool pressing a solar cell module against a seat member has a configuration including an upper surface abutment portion that abuts against the upper surface of the module, a side surface abutment portion that abuts against the side surface of the module, a base portion that extends from the side surface abutment portion, an insertion hole that penetrates through the base portion and through which the bolt is inserted, a bolt upper abutment portion that is a portion of an inner circumferential surface of the insertion hole against which an upper portion of an external thread portion of the bolt is made to abut, and a bolt lower abutment portion with which a lower portion of the external thread portion is made to abut, and a height H of the side surface abutment portion is set to be smaller than a height h1 of the module.

### BACKGROUND OF THE INVENTION

### Field of the Invention

The present invention relates to a mounting structure for a solar cell module and a mounting tool that is used for the mounting structure.

### Description of the Related Art

As a mounting structure in which a solar cell module is mounted on a mounting object such as a roof, the present applicant has proposed a structure in which the solar cell module is installed on crosspiece members secured to the mounting object and is pressed against the crosspiece members to be secured with mounting tools (see, Japanese Patent Application Laid-open No. 2010-261257).

Each of the mounting tools includes an upper abutment portion that is made to abut against the upper surface of the solar cell module and leg portions of which the lower ends are made to abut against the upper surface of the crosspiece member. The solar cell module is pressed against the crosspiece members to be secured to the crosspiece members by fastening the upper abutment portions and the leg portions with bolts extending from the crosspiece members and nuts.

Some solar cell modules are different in height of side surfaces. For this reason, conventionally, a plurality of types of mounting tools including the leg portions that are different in height are required in accordance with the difference in height among the solar cell modules, resulting in a risk of cumbersome material management.

### SUMMARY OF THE INVENTION

Accordingly, in view of the above-described circumstances, it is an object of the present invention to provide a mounting structure for a solar cell module, which enables mounting of each of a large variety of solar cell modules having different heights on a mounting object with one type of mounting tool, and the mounting tool.

In order to achieve the above-mentioned object, a mounting structure for a solar cell module according to an aspect of the invention “includes:
a seat member that is secured to a mounting object;
a solar cell module that is installed on an upper surface of the seat member; and
a mounting tool that presses the solar cell module against the seat member by fastening a bolt which is parallel with a side surface of the solar cell module and an internal thread portion which is screwed together with an external thread portion of the bolt,
wherein the mounting tool includes:
   a flat plate-like upper surface abutment portion that abuts against an upper surface of the solar cell module and one end side of which extends along one side of the solar cell module;
   a side surface abutment portion that extends downward from the end side of the upper surface abutment portion so as to be shorter than a height of the side surface of the solar cell module and at least a part of which abuts against the side surface of the solar cell module;
   a base portion that extends to an opposite side to the upper surface abutment portion side from a halfway position of the side surface abutment portion in an up-down direction;
   an insertion hole that penetrates through the base portion in the up-down direction and through which the external thread portion is inserted;
   a bolt upper abutment portion that is a portion of an inner circumferential surface of the insertion hole at an upper end side and abuts against a portion of the external thread portion, which is close to the upper surface abutment portion; and
   a bolt lower abutment portion that abuts against a portion of the external thread portion, which is farther from the upper surface abutment portion, in a lower position relative to the bolt upper abutment portion, and
   the bolt lower abutment portion is a portion of the inner circumferential surface of the insertion hole at a lower end side or a portion extending downward from an end portion of the base portion at an opposite side to an end portion at the side surface abutment portion side”.

Examples of the “mounting object” can include a “roof structural material” such as balk and roofboard, a “roof material” covering roof, a “member that is mounted on roof” for installing the solar cell module, a “wall surface of a building”, and a “base (foundation) that is provided on the ground”.

Examples of the “seat member” can include a “member having a length enabling only one side of the solar cell module to be installed thereon, that is, a length which is smaller than that of one side of the solar cell module”, a “member having a length enabling one solar cell module to be installed thereon, that is, a length which is larger than that of one side of the solar cell module”, and a “member having a length enabling equal to or more than two solar cell modules to be installed thereon”.

Examples of a combination mode of the “bolt” and the “internal thread portion” which is screwed together with the external thread portion of the bolt can include a “mode in which the external thread portion of the bolt having a head on the lower end thereof is inserted through a hole or a groove formed in the upper surface of the seat member from below so as to project upward and is screwed together with a nut as the internal thread portion”, a “mode in which the lower end of the bolt having no head is screwed together with an internal thread hole formed in the seat member to be secured and the other end side of the external thread portion is screwed together with a nut as the internal thread portion”, a “mode in which the lower end of the bolt having no head is welded on the seat member and the other end side of the external thread portion is screwed together with a nut as the internal thread portion”, a “mode in which the external thread portion of the bolt having a head on the upper end thereof is inserted through a hole or a groove formed in the upper surface of the seat member from above and is screwed together with a nut member as the internal thread portion inside of the seat member”, and a “mode in which the external thread portion of the bolt having a head is screwed together with an internal thread hole as the internal thread portion formed on the seat member”.

In the mounting structure for the solar cell module, which has this configuration, the upper surface abutment portion of the mounting tool abuts against the upper surface of the solar cell module and the solar cell module is pressed against the seat member with the upper surface abutment portion by fastening the external thread portion of the bolt and the internal thread portion with each other, thereby mounting the solar cell module on the seat member.

The end portion of the base portion, which is close to the solar cell module, that is, the end portion thereof at the boundary with the side surface abutment portion is restricted from moving downward by the upper surface abutment portion that abuts against the upper surface of the solar cell module. On the other hand, the end portion of the base portion at the opposite side is a free end and is not restricted from moving downward. When the external thread portion and the internal thread portion are fastened with each other in this state, downward force acts on the base portion and the mounting tool is apt to rotate about the vicinity of the upper surface abutment portion in the direction in which the free end side of the base portion moves downward.

To cope with this situation, with this configuration, at least a part of the side surface abutment portion is made to abut against the side surface of the solar cell module, the bolt upper abutment portion is made to abut against an upper portion (portion which is close to the upper abutment portion) of the external thread portion of the bolt, and the bolt lower abutment portion is made to abut against a lower portion (portion which is farther from the upper surface abutment portion) of the external thread portion of the bolt. This configuration hinders the mounting tool from rotation by interference at a plurality of places, which includes abutment between the side surface abutment portion and the solar cell module, abutment between the bolt upper abutment portion and the upper portion of the bolt, and abutment between the bolt lower abutment portion and the lower portion of the bolt, even when the mounting tool is apt to rotate about the vicinity of the upper surface abutment portion by fastening the external thread portion and the internal thread portion with each other. Accordingly, the upper surface abutment portion is not detached from the upper surface of the solar cell module and the solar cell module can be pressed against the seat member using the mounting tool without rotation of the mounting tool when the external thread portion fastens with the internal thread portion.

With this configuration, the height of the side surface abutment portion of the mounting tool, that is, the length by which the side surface abutment portion extends from the upper surface abutment portion is made to be smaller than the height of the side surface of the solar cell module. Furthermore, unlike the above-described conventional technique, the mounting tool includes no leg portion that is made to abut against the upper surface of the seat member on which the solar cell module is installed. The solar cell module having the side surface the height of which is larger than the height of the side surface abutment portion of the mounting tool can be mounted by this mounting tool. Therefore, each of a variety of solar cell modules having the side surfaces heights of which are different can be mounted on the seat member using one type of mounting tool. Moreover, a variety of mounting tools for coping with the difference in height among the solar cell modules are not required, thereby avoiding cumbersome material management.

In the mounting structure for the solar cell module in the aspect of the present invention, the configuration in which “the seat member has a long groove that penetrates through an upper surface portion, the external thread portion of the bolt, which extends upward through the long groove, is inserted through the insertion hole in a state in which a head of the bolt having such size that the head does not pass through the long groove is located inside the seat member, and the internal thread portion is a nut that abuts against the base portion from above by being fastened with the external thread portion” can be employed in addition to the above-described configuration. Alternatively, the configuration in which “the seat member has a long groove that penetrates through an upper surface portion, the external thread portion of the bolt, which extends downward through the insertion hole, is inserted through the long groove in a state in which a head of the bolt having such size that the head does not pass through the insertion hole is made to abut against the base portion from above, and the internal thread portion is a nut member that is screwed together with the external thread portion in an internal thread hole and abuts against the upper surface portion from below by being fastened with the external thread portion in a state of being located inside the seat member” can be employed.

With any of the above-described configurations, the solar cell module is pressed against the seat member by the mounting tool causing the upper surface abutment portion to abut against the upper surface of the solar cell module, thereby securing the solar cell module to the mounting object with the seat member interposed therebetween.

Furthermore, with any of the above-described configurations, the seat member has the long groove and the external thread portion of the bolt is fastened with the internal thread portion in a state of passing through the long groove. Therefore, a mounting position of the solar cell module on the seat member can be easily adjusted by causing the external thread portion to slide along the long groove.

A mounting tool according to another aspect of the present invention “includes:
an upper surface abutment portion that has a flat plate-like shape and at least one end side of which is linear;
a side surface abutment portion that extends at a right angle from the linear end side;
a base portion that extends to an opposite side to the upper surface abutment portion side from a halfway position of the side surface abutment portion in an extension direction and has a larger thickness than thicknesses of the upper surface abutment portion and the side surface abutment portion;
an insertion hole that penetrates through the base portion in a thickness direction; and
a lightening hole that is orthogonal to the insertion hole and penetrates through the base portion in a direction which is parallel with the side surface abutment portion”.

The mounting tool having this configuration is used for the above-described mounting structure for the solar cell module. The above-described action effects are exerted by mounting the solar cell module on the seat member using the mounting tool. In addition, the mounting tool having this configuration includes the lightening hole in the base portion and the usage amount of a material forming the mounting tool is reduced for the amount of the lightening hole. The mounting tool can therefore be reduced in weight and manufacturing cost.

As described above, it is possible to provide a mounting structure for a solar cell module, which enables mounting of each of a large variety of solar cell modules having different heights on a mounting object with one type of mounting tool, and the mounting tool.

### BRIEF DESCRIPTION OF THE DRAWINGS

FIG. 1 is a perspective view of a mounting structure for a solar cell module as a first embodiment;

FIG. 2 is a cross-sectional view of a main part of the mounting structure for the solar cell module in FIG. 1;

FIG. 3 is a perspective view of a mounting tool that is used for the mounting structure for the solar cell module in FIG. 1;

FIG. 4 is a cross-sectional view of the main part of the mounting structure in which a solar cell module having a different height from that in FIG. 1 is mounted on a seat member by the mounting tool in FIG. 1;

FIGS. 5A to 5D are front views of mounting tools (examples in which a shape(s) of a base portion and/or a lightening hole is(are) different) in variations;

FIG. 6 is a front view of a mounting tool (example in which it has no lightening hole) in another variation;

FIGS. 7A and 7B are front views of mounting tools (examples in which a bolt lower abutment portion is a portion extending downward from an end portion of the base portion) in still other variations;

FIG. 8 is a cross-sectional view of a main part of a mounting structure for a solar cell module using a mounting tool (example in which it includes a portion supporting an eaves cover) in still another variation;

FIG. 9 is a perspective view of a mounting structure for a solar cell module as a second embodiment;

FIG. 10 is a perspective view of a seat member and a nut member that are used for the mounting structure for the solar cell module in FIG. 9;

FIG. 11A is a perspective view when a projection is provided on the mounting tool in FIG. 3 and FIG. 11B is a perspective view when the mounting tool in FIG. 11A is seen from the bottom surface side;

FIG. 12A is a perspective view when another projection is provided on the mounting tool in FIG. 3 and FIG. 12B is a perspective view when the mounting tool in FIG. 12A is seen from the bottom surface side; and

FIG. 13 is a perspective view of a mounting structure for a solar cell module as another embodiment.

### DESCRIPTION OF THE EMBODIMENTS

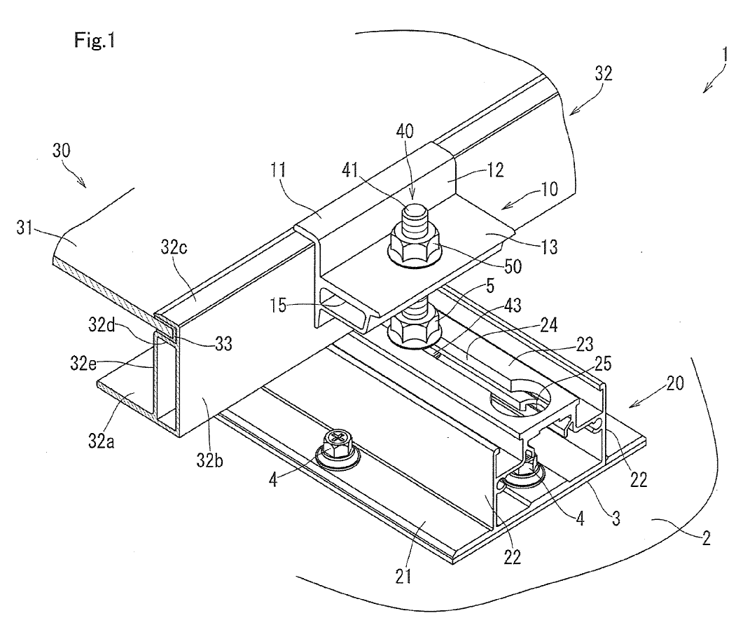

A mounting structure 1 for a solar cell module (hereinafter, simply referred to as a “mounting structure 1”) as a first embodiment of the present invention and a mounting tool 10 that is used for the mounting structure 1 will be described with reference to FIG. 1 to FIG. 3.

The mounting structure 1 includes a seat member 20 that is secured onto a roof material 2 as a mounting object, a solar cell module 30 that is installed on the upper surface of the seat member 20, a mounting tool 10 for securing the solar cell module 30 to the seat member 20, a bolt 40, and a nut 50 as an internal thread portion. The roof material 2 in the embodiment is any one of slate, asphalt single, and a roof plate made of metal.

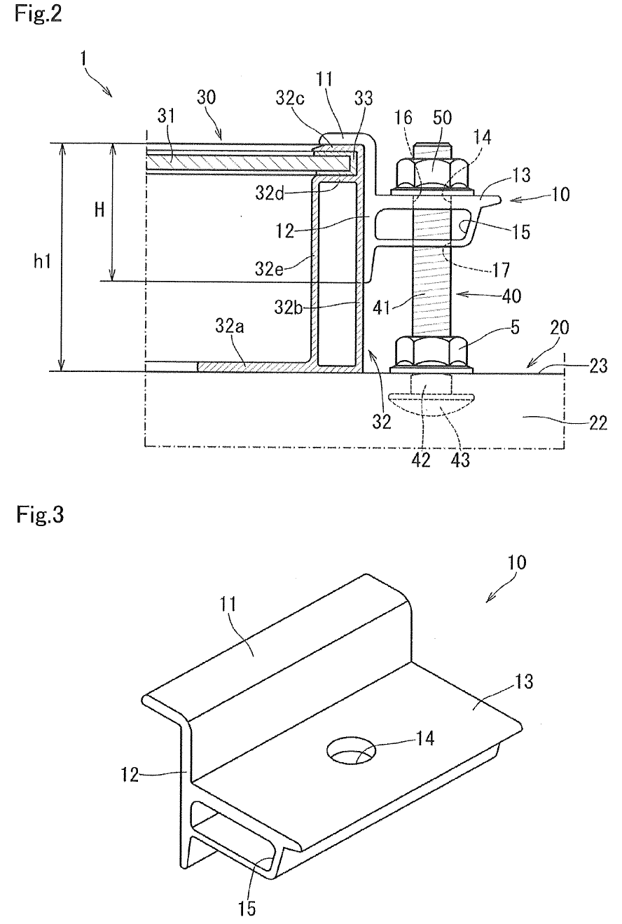

The solar cell module 30 includes a flat plate-like solar cell panel 31 the outer shape of which is a rectangular shape when seen from above and frame bodies 32 that are mounted on respective sides of the solar cell panel 31. Each frame body 32 includes a flat plate-like lower frame 32a, a flat plate-like side frame 32b that extends upward at a right angle from one of the end sides of the lower frame 32a, a flat plate-like upper frame 32c that extends from the upper end of the side frame 32b in the same direction as the lower frame 32a in parallel therewith, a holding frame 32d that extends from the side frame 32b in the same direction as the upper frame 32c in parallel therewith with a space from the upper frame 32c, and an inner frame 32e that connects the holding frame 32d and the lower frame 32a and is in parallel with the side frame 32b (see FIG. 1 and FIG. 2). The frame body 32 has a single cross-sectional shape orthogonal to the lengthwise direction and is formed by extrusion molding of metal such as aluminum alloy.

In the solar cell module 30 having the above-described configuration, the solar cell panel 31 is pressed into between the upper frames 32c and the holding frames 32d with seal members 33 interposed therebetween, so that the solar cell panel 31 is held by the frame bodies 32. Furthermore, in each frame body 32, the surface of the side frame 32b at the opposite side to the side facing the inner frame 32e configures the “side surface of the solar cell module 30” and the upper surface of the upper frame 32c configures a part of the “upper surface of the solar cell module 30”. It should be noted that a height h1 of the side surface of the solar cell module 30 is 50 mm as an example.

The mounting tool 10 includes an upper surface abutment portion 11, a side surface abutment portion 12, a base portion 13, an insertion hole 14, a lightening hole 15, a bolt upper abutment portion 16, and a bolt lower abutment portion 17.

The upper surface abutment portion 11 has a flat plate-like rectangular shape. The upper surface of the solar cell module 30 is made to abut against the lower surface of the upper surface abutment portion 11. The side surface abutment portion 12 has a flat plate-like shape and extends at a right angle from one of the longer sides of the upper surface abutment portion 11. The side surface of the solar cell module 30 is made to abut against the surface of the side surface abutment portion 12 at the upper surface abutment portion 11 side. A height H of the side surface abutment portion 12, that is, the length H from the boundary with the upper surface abutment portion 11 to the lower end of the side surface abutment portion 12 is smaller than the height h1 of the side surface of the solar cell module 30. The height H of the side surface abutment portion 12 is 30 mm in this example.

The base portion 13 extends to the opposite side to the upper surface abutment portion 11 from a halfway position of the side surface abutment portion 12 in the extension direction. The upper surface of the base portion 13 is flat and the thickness of the base portion 13 is larger than the respective thicknesses of the upper surface abutment portion 11 and the side surface abutment portion 12. In the embodiment, the lower surface and the upper surface of the base portion 13 are parallel with each other and the base portion 13 is formed such that the thickness in the vicinity of the free end at the opposite side to the side surface abutment portion 12 is smaller than those of other portions.

The insertion hole 14 is a circular hole and penetrates through the base portion 13 in the thickness direction at the center thereof. The lightening hole 15 is a quadrangular hole, is orthogonal to the insertion hole 14 and penetrates through the base portion 13 in the direction which is parallel with the side surface abutment portion 12. Accordingly, in the embodiment, the insertion hole 14 is divided into upper—lower two holes by the lightening hole 15. When the bolt 40 is inserted through the insertion hole 14, the inner circumferential surface of the insertion hole 14 at the upper side abuts against a portion of the external thread portion 41, which is close to the upper surface abutment portion 11 whereas the inner circumferential surface of the insertion hole 14 at the lower side abuts against a portion of the external thread portion 41, which is farther from the upper surface abutment portion 11. In the embodiment, in the insertion hole 14 divided into two, the inner circumferential surface of the insertion hole 14 at the upper side is the bolt upper abutment portion 16 corresponding to a “portion of the inner circumferential surface of the insertion hole at the upper end side” and the inner circumferential surface of the insertion hole 14 at the lower side is the bolt lower abutment portion 17 corresponding to a “portion of the inner circumferential surface of the insertion hole at the lower end side”.

The mounting tool 10 is provided by performing extrusion molding on metal such as aluminum alloy so as to have a single cross-sectional shape orthogonal to the lengthwise direction, and then, cutting it by the length of 50 mm to 200 mm and forming the insertion hole 14 therein by punching processing.

The seat member 20 includes a bottom surface portion 21 that has a flat plate-like rectangular shape, a pair of standing wall portions 22 that stand on the bottom surface portion 21, and an upper surface portion 23 that is supported by the pair of standing wall portions 22 at a position higher than the bottom surface portion 21 (see FIG. 1). The seat member 20 includes a long groove 24 that penetrates through the upper surface portion 23 and both ends of which are closed, a head insertion hole 25 that has a larger diameter than the width of the long groove 24, penetrates through the upper surface portion 23, and communicates with the long groove 24 at one end of the long groove 24, and a securing hole (not illustrated) that penetrates through the bottom surface portion 21.

In the embodiment, the seat member 20 is set to have a length enabling only one side of the solar cell module 30 to be installed thereon, that is, a length which is smaller than the shorter sides of the solar cell module 30. The seat member 20 is provided by performing extrusion molding on metal such as aluminum alloy, and then, cutting it by the length of 100 mm to 300 mm and forming the long groove 24, the head insertion hole 25, and the securing hole therein by drilling processing or punching processing.

The bolt 40 is made of stainless steel, and has the external thread portion 41 in which an external thread is formed on the outer circumference thereof, a head 43 at one end thereof, and a square root portion 42 formed on a base end of the external thread portion 41 for the head 43. The head 43 has such size that it does not pass through the long groove 24 of the seat member 20 and is smaller than the head insertion hole 25. The square root portion 42 is a regular prism having a square outer shape and the length of one side of the square is slightly smaller than the width of the long groove 24. The length of the bolt 40 is set such that when the lower end of the bolt 40 is secured to the seat member 20, the height of the upper end is substantially the same as that of the upper end of the solar cell module 30 installed on the seat member 20.

The nut 50 as the internal thread portion in the embodiment is a hexagonal nut with a washer made of stainless steel.

Next, procedures of mounting of the solar cell modules 30 on the roof material 2 as the mounting object using the above-described mounting tools 10 and the mounting structures 1 constructed by the procedures are described. First, the seat members 20 for the number determined based on the number of solar cell modules 30 and the size thereof are secured to the roof material 2. To be specific, the respective seat members 20 are secured such that the lengthwise directions thereof are set to the inclination direction of the roof and the head insertion holes 25 are located at the ridge side relative to the long grooves 24. An interval between the adjacent seat members 20 is set to be equal to the length of the shorter sides of each solar cell module 30 in the roof inclination direction and is set to half of the length of the longer sides of each solar cell module 30 in the direction (also referred to as a “lateral direction”) which is perpendicular to the inclination direction.

Waterproof sheets 3 (see FIG. 1) made of butyl rubber are interposed between the roof material 2 and the seat members 20 and the seat members 20 are secured to the roof material 2 with screws 4 inserted through the securing holes formed in the bottom surface portions 21. In this case, the screws 4 are made to penetrate through the roof material 2 and are screwed into a roof structural material (balk or roofboard) supporting the roof material 2.

Then, in the plurality of seat members 20 aligned in the most eaves-side row, the bolts 40 are inserted through the head insertion holes 25 from above while the heads 43 of the bolts 40 face down, the bolts 40 are made to slide in the lengthwise direction of the seat members 20, and the external thread portions 41 are made to extend upward from the upper surface portions 23 through the long grooves 24. Nuts 5 are screwed together with the external thread portions 41 in this state to hold the postures of the bolts 40. Thereafter, the respective bolts 40 are made to slide in the roof inclination direction along the long grooves 24 and are adjusted so as to be aligned in a straight line in the lateral direction of the roof. The nuts 5 are then fastened to secure the bolts 4 to the seat members 20. The bolts 40 have the square root portions 42 and can therefore be moved along the long grooves 24 without being rotated.

The eaves-side end sides of the solar cell modules 30 are installed on the upper surface portions 23 of the seat members 20 at the eaves side so as to be located at the ridge side relative to the bolts 40. Together with this installation, the ridge-side end sides of the solar cell modules 30 are installed on the upper surfaces of the seat members 20 at the ridge side. Subsequently, the mounting tools 10 are directed such that the upper surface abutment portions 11 are located at the ridge side and the bolts 40 projecting upward from the seat members 20 at the eaves side are inserted through the insertion holes 14 of the mounting tools 10 from below. After that, the solar cell modules 30 are made to slide in the roof inclination direction and the eaves-side side surfaces of the solar cell modules 30 are made to abut against the side surface abutment portions 12 of the mounting tools 10. Simultaneously, the upper surface abutment portions 11 of the mounting tools 10 are made to abut against the upper surfaces of the solar cell modules 30.

In this state, the nuts 50 are screwed together with and fastened with the external thread portions 41 projecting upward through the through-holes 14 of the mounting tools 10. With this, the upper surface abutment portions 11 abut against the upper surfaces of the solar cell modules 30, the nuts 50 abut against the upper surfaces of the base portions 13, and the upper surface abutment portions 11 press the solar cell modules 30 against the seat members 20. The eaves-side end sides of the solar cell modules 30 are thereby made into states of being secured to the seat members 20.

Furthermore, in the state in which the nuts 50 have been fastened, the side surface abutment portions 12 abut against the eaves-side side surfaces of the solar cell modules 30, the bolt upper abutment portions 16 abut against the portions of the external thread portions 41, which are close to the upper surface abutment portions 11, and the bolt lower abutment portions 17 abut against the portions of the external thread portions 41, which are farther from the upper surface abutment portions 11. Therefore, even when the mounting tools 10 is apt to rotate about the vicinities of the upper surface abutment portions 11 with fastening forces between the bolts 40 and the nuts 50, the rotation of the mounting tools 10 is hindered with abutment between the side surface abutment portions 12 and the solar cell modules 30, abutment between the bolt upper abutment portions 16 and the bolts 40, and abutment between the bolt lower abutment portions 17 and the bolts 40. Accordingly, detachment of the upper surface abutment portions 11 from the upper surfaces of the solar cell modules 30 due to undesired rotation of the mounting tools 10 does not occur.

After the eaves-side end sides of the solar cell modules 30 are mounted on the respective seat members 20 in the eaves side row using the mounting tools 10, the ridge-side end sides of the solar cell modules 30 are mounted. In the same manner as the seat members 20 at the eaves side, in the seat members 20 on which the ridge-side end sides of the solar cell modules 30 are installed, the bolts 40 are inserted through the head insertion holes 25 from above while the heads 43 of the bolts 40 face down, the bolts 40 are made to slide in the lengthwise direction of the seat members 20, and the external thread portions 41 are made to extend upward from the upper surface portions 23 through the long grooves 24. The nuts 5 are screwed together with the external thread portions 41 in this state to hold the postures of the bolts 40. Subsequently, the mounting tools 10 are directed such that the upper surface abutment portions 11 are located at the eaves side, the external thread portions 41 projecting upward from the seat members 20 are inserted through the insertion holes 14 of the mounting tools 10 from below, and the nuts 50 are screwed together with the front ends of the external thread portions 41.

After that, the bolts 40 are made to slide to the eaves side along the long grooves 24 together with the mounting tools 10 and the side surface abutment portions 12 of the mounting tools 10 are made to abut against the ridge-side side surfaces of the solar cell modules 30. In this state, the nuts 5 are fastened with the external thread portions 41. Furthermore, the upper surface abutment portions 11 of the mounting tools 10 are made to abut against the upper surfaces of the solar cell modules 30 and the nuts 50 are fastened with the external thread portions 41 in this state. The ridge-side end sides of the solar cell modules 30 are thereby made into states of being secured to the seat members 20 at the ridge side.

With the above-described procedures, both of the eaves-side end sides and the ridge-side end sides of the solar cell modules 30 are made into the states of being pressed, by the mounting tools 10, against the seat members 20 on which they are respectively installed. In this manner, the mounting structure 1 in which the solar cell modules 30 are mounted on the roof material 2 is constructed.

It should be noted that before the above-described mounting, a process of temporarily assembling the nuts 5, the mounting tools 10, and the nuts 50 previously, that is, a process of inserting the external thread portions 41 screwed together with the nut 5 through the insertion holes 14 of the mounting tools 10 and further screwing the nuts 50 together with the external thread portions 41 may be performed. The heads 43 of the bolts 40 are inserted through the head insertion holes 25 of the seat members 20 in the temporarily assembled state. Thereafter, the operations that are same as the above-described operations are performed.

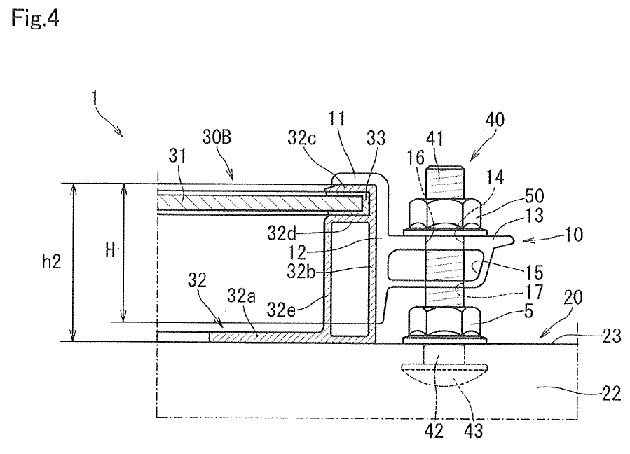

As described above, according to the embodiment, the mounting tool 10 with which the solar cell module 30 is mounted on the seat member 20 has the side surface abutment portion 12 the height H of which is smaller than the height h1 of the side surface of the solar cell module 30 and include no leg portion that is employed in the above mentioned conventional technique to abut against the upper surface of the seat member 20 on which the solar cell module 30 is installed. With this configuration, as illustrated in FIG. 2, the solar cell module 30 can be mounted with the mounting tool 10 as long as the height h1 of the side surface of the solar cell module 30 is larger than the height H of the mounting tool 10. For example, as illustrated in FIG. 4, even a solar cell module 30B having side surfaces a height h2 of which is smaller than h1 can be mounted on the seat member 20 using the mounting tool 10 as long as the height h2 is larger than the height H of the side surface abutment portion 11 of the mounting tool 10. The solar cell module 30B in FIG. 4 is different from the solar cell module 30 in FIG. 2 only in the height and detail description thereof is omitted while the same reference numerals denote the same components.

Accordingly, each of a variety of solar cell modules having the side surfaces heights of which are different can be mounted on the seat member 20 using the mounting tool 10. Furthermore, the number of types of mounting tools that are necessary for coping with the difference in height among the solar cell modules can be reduced, thereby reducing the risk of cumbersome material management.

The mounting tool 10 includes the lightening hole 15 that penetrates through the base portion 13 and the usage amount of a material forming the mounting tool 10 is reduced for the amount of the lightening hole 15. The mounting tool 10 can therefore be reduced in weight.

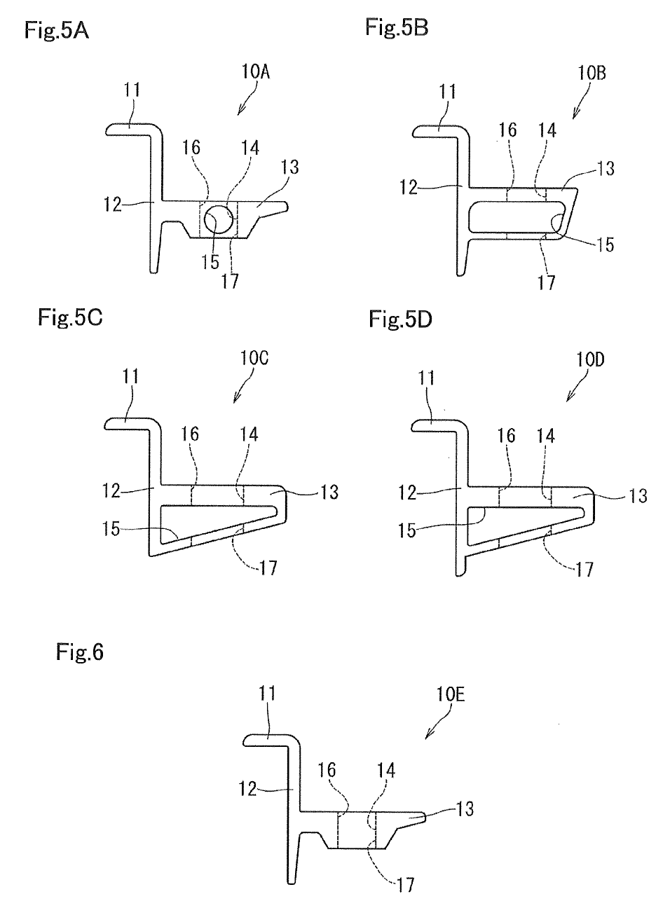

Various variations of the mounting tool as illustrated in FIG. 5A to FIG. 8 can be implemented by making the shape(s) of the base portion 13 and/or the lightening hole 15, presence and absence of the lightening hole, and the configuration of the bolt lower abutment portion different. Even each of mounting tools 10A to 10H in the variations can construct the mounting structure 1 by being used in the same manner as the mounting tool 10.

FIG. 5A to FIG. 5D illustrate examples in which the shape(s) of the base portion 13 and/or the lightening hole 15 is(are) different from that(those) of the mounting tool 10. The mounting tool 10A in FIG. 5A is formed such that only the vicinity of a portion of the base portion 13 in which the insertion hole 14 is formed is increased in thickness and the lightening hole 15 is a circular hole having a smaller diameter than that of the insertion hole 14. The mounting tool 10A has the insertion hole 14 as one hole unlike the mounting tool 10 having the insertion hole 14 divided into two by the lightening hole 15. Therefore, a portion of the inner circumferential surface of the insertion hole 14 at the upper end side is the bolt upper abutment portion 16 and a portion of the inner circumferential surface thereof at the lower end side is the bolt lower abutment portion 17. The mounting tool 10B in FIG. 5B is the same as the mounting tool 10 in the point that the lower surface of the base portion 13 is in parallel with the upper surface thereof. The mounting tool 10B in FIG. 5B is however formed such that the substantially entire thickness is constant unlike the mounting tool 10 formed such that the thickness of the end portion of the base portion 13 at the opposite side to the end portion thereof at the side surface abutment portion 12 side is smaller than those of other portions.

The mounting tool 10C in FIG. 5C is formed such that the thickness of the base portion 13 is gradually reduced toward the free end and the lower surface of the base portion 13 is inclined upward toward the free end with the above-described gradual reduction in thickness. Furthermore, the mounting tool 10C has the lightening hole 15 of a triangular shape. The mounting tool 10D in FIG. 5D is the same as the mounting tool 10C in the shapes of the base portion 13 and the lightening hole 15. The mounting tool 10D in FIG. 5D is however formed such that the boundary between the lower surface of the base portion 13 and the side surface abutment portion 12 is located at an upper position relative to the lower end of the side surface abutment portion 12 unlike the mounting tool 10C in which the boundary between the lower surface of the base portion 13 and the side surface abutment portion 12 is located at the lower end of the side surface abutment portion 12.

FIG. 6 is an example of a mounting tool having no lightening hole 15. The mounting tool 10E in FIG. 6 is formed by removing the lightening hole 15 from the mounting tool 10A in FIG. 5A.

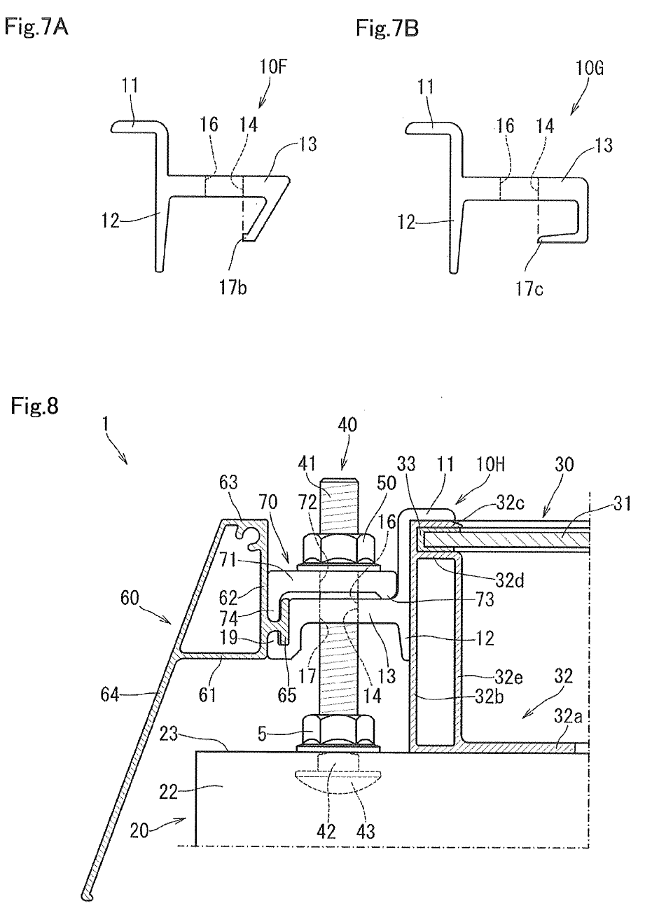

All of the mounting tool 10 and the mounting tools 10A to 10En are examples in which the portion of the inner circumferential surface of the insertion hole 14 at the lower end side is the bolt lower abutment portion 17. By contrast, as illustrated in FIGS. 7A and 7B, a portion that extends downward from an end portion (hereinafter, referred to as an “outer end”) of the base portion 13 at the opposite side to the end portion thereof at the side surface abutment portion 12 side can be formed as a bolt lower abutment portion 17b or 17c. To be specific, the mounting tool 10F in FIG. 7A is formed such that the base portion 13 has a flat plate shape and the bolt lower abutment portion 17b extends downward obliquely toward the side surface abutment portion 12 from the outer end of the base portion 13, and then, is bent in parallel with the base portion 13. The front end of the bolt lower abutment portion 17b reaches a position under the insertion hole 14. Therefore, when the bolt 40 is inserted through the insertion hole 14, a portion of the external thread portion 41, which is farther from the upper surface abutment portion 11, abuts against the bolt lower abutment portion 17b. On the other hand, the bolt lower abutment portion 17c of the mounting tool 10G in FIG. 7B is bent downward at a right angle from the outer end of the flat plate-like base portion 13, and then, is bent to the side surface abutment portion 12 side in parallel with the base portion 13 to cause the front end thereof to reach the position under the insertion hole 14.

FIG. 8 is an example of the mounting tool having a portion supporting an eaves cover 60. The mounting tool 10H in FIG. 8 enables the eaves cover 60 to be mounted on the seat member 20 in addition to the solar cell module 30 by being combined with an engaging tool 70. An engaging portion 19 of the mounting tool 10H supports the eaves cover 60. The engaging portion 19 has such hook shape that it extends downward at a right angle from the outer end of the base portion 13, and then, is bent to the opposite side to the side surface abutment portion 12, and the front end thereof is further bent upward. The mounting tool 10H has no lightening hole 15 and a portion of the inner circumferential surface of the insertion hole 14 at the lower end side is the bolt lower abutment portion 17.

The eaves cover 60 includes a bottom plate portion 61, a standing plate portion 62, a top plate portion 63, an oblique plate portion 64, and an engagement target portion 65. The bottom plate portion 61 has a flat plate-like shape. The standing plate portion 62 has a flat plate-like shape and extends upward at a right angle from one of the end sides of the bottom plate portion 61. The top plate portion 63 extends above the bottom plate portion 61 from the upper end of the standing plate portion 62 in parallel with the bottom plate portion 61 so as to be shorter than the bottom plate portion 61. The oblique plate portion 64 connects the end side of the bottom plate portion 61 at the opposite side to the side at which the standing plate portion 62 extends and the front end of the top plate portion 63, and extends obliquely to a lower position relative to the bottom plate portion 61. The engagement target portion 65 projects in the opposite direction to the oblique plate portion 64 from a halfway portion of the standing plate portion 62 in the up-down direction and the front end thereof is further bent in both of upper and lower directions. The thus configured eaves cover 60 has the same length as the longer sides of the solar cell module 30 and has a single cross-sectional shape orthogonal to the lengthwise direction.

The engaging tool 70 includes a projecting portion 73 at one end of a flat plate-like main body 71 and an engaging portion 74 at the other end thereof. The projecting portion 73 projects downward from one end of the main body 71. The engaging portion 74 projects from the other end of the main body 71 in the same direction as the projecting portion 73 so as to be longer than the projecting portion 73 and is engaged with the engagement target portion 65 of the eaves cover 60 from above. A through-hole 72 through which the bolt 40 is inserted is provided in the main body 71 in a penetrating manner.

Mounting of the eaves cover 60 using the mounting tool 10H is described. The mounting tool 10H is used when mounting the eaves-side end side of the solar cell module 30 at the row of most eaves side on the seat member 20. First, the mounting tool 10H is made into a state in which the upper surface abutment portion 11 faces the ridge side, the external thread portion 41 projecting upward form the seat member 20 is inserted through the insertion hole 14 from below, and the upper surface abutment portion 11 is made to abut against the upper surface of the solar cell module 30. Subsequently, the eaves cover 60 is made into a state in which the oblique plate portion 64 faces the eaves side and the engagement target portion 65 is engaged with the engaging portion 19 of the mounting tool 10H from above. Thereafter, the mounting tool 70 is made into a state in which the engaging portion 74 faces the eaves side, the external thread portion 41 projecting upward from the base portion 13 of the mounting tool 10H is inserted through the insertion hole 72 from below, and the engaging portion 74 is engaged with the engagement target portion 65 of the eaves cover 60 from above. Then, the nut 50 is screwed together with and fastened with the external thread portion 41 projecting upward from the engaging tool 70. With this, the upper surface abutment portion 11 of the mounting tool 10H presses the eaves-side end side of the solar cell module 30 against the seat member 20, and the engagement target portion 65 of the eaves cover 60 is interposed between the engaging portion 19 of the mounting tool 10H and the engaging portion 74 of the engaging tool 70.

Accordingly, usage of the mounting tool 10H enables the eaves-side end side of the solar cell module 30 and the eaves cover 60 to be simultaneously mounted on the roof material 2 with the seat member 20 interposed therebetween. An outer appearance when the solar cell module 30 installed on the roof is seen from the eaves side can be made preferable with the eaves cover 60.

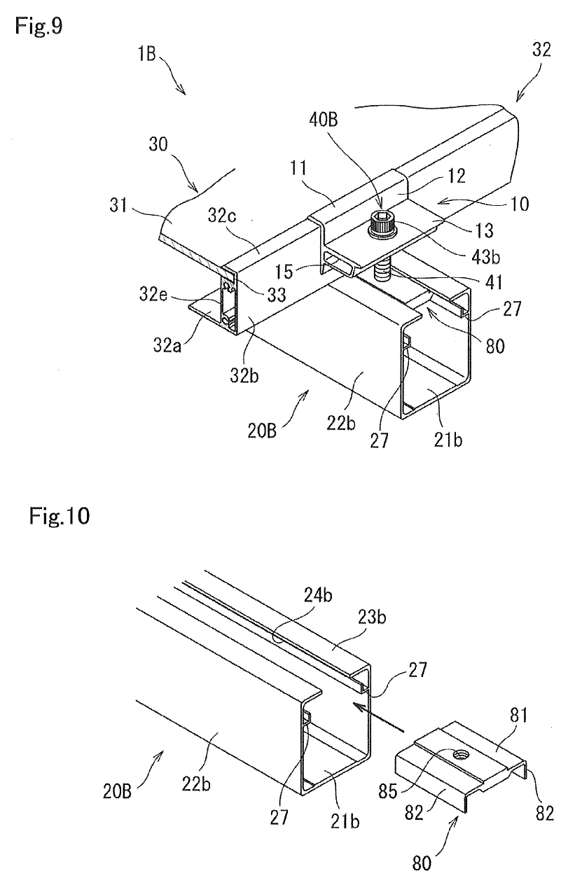

Next, a mounting structure 1B in a second embodiment will be described with reference to FIG. 9 and FIG. 10. The mounting structure 1B is different from the mounting structure 1 in the first embodiment in the bolt direction, and the configurations of the internal thread portion and the seat member are different in accordance with the bolt direction. In the mounting structure 1, the bolt 40 is screwed together with the internal thread portion in the state in which the head 43 thereof faces downward, that is, in an inverted state whereas in the mounting structure 1B, a bolt 40B is screwed together with an internal thread portion in a state in which a head 43b faces upward. Although the mounting tool 10 as described above with reference to FIGS. 1 to 4 is illustrated in FIG. 9 as the mounting tool, the mounting structure 1B can also be constructed using a mounting tool in another embodiment as exemplified by the mounting tools 10A to 10H.

A seat member 20B that is used for the mounting structure 1B is a channel steel formed by connecting a bottom surface portion 21b and an upper surface portion 23b by a pair of standing wall portions 22b, and is a lip channel steel having a long groove 24b penetrating through the upper surface portion 23b in the thickness direction and the lengthwise direction. Rails 27 that extend inward from the pair of standing wall portions 22b in parallel with the upper surface portion 23b are formed over the entire length of the standing wall portions 22b in the lengthwise direction. The front ends of the respective rails 27 are bent at right angles toward the upper surface portion 23b.

The internal thread portion in the mounting structure 1B is a nut member 80 and has an internal thread hole 85 that is screwed together with the external thread portion 41 of the bolt 40B. The nut member 80 has a main body 81 having a quadrangular shape when seen from above and bent portions 82 extending at right angles in the same direction from a pair of sides of the main body 81. The internal thread hole 85 is provided at the center of the main body 81. A distance between the pair of bent portions 82 is slightly smaller than a distance between the pair of standing wall portions 22b of the seat member 20B. The nut member 80 can therefore be inserted into the seat member 20B through an end opening thereof in the lengthwise direction as illustrated in FIG. 10, and can be made to slide in the lengthwise direction of the seat member 20B in a state in which the pair of bent portions 82 are installed on and engaged with the rails 27 of the seat member 20B.

The bolt 40B has the head 43b having such size that it does not pass through the insertion hole 14, and is inserted through the insertion hole 14 from above of the base portion 13 of the mounting tool 10 in a state in which the head 43b faces upward. The front end of the external thread portion 41 extending downward through the insertion hole 14 is inserted through the long groove 24b of the seat member 20B and is screwed together with the internal thread hole 85 of the nut member 80 located inside the seat member 20B. When the external thread portion 41 is fastened with the internal thread hole 85, the upper surface abutment portions 11 of the mounting tool 10 abuts against the upper surface of the solar cell module 30, the head 43b of the bolt 40B abuts against the upper surface of the base portion 13, and the upper surface abutment portion 11 presses the solar cell module 30 against the seat member 20B in the same manner as the above-described mounting structure 1. The mounting structure 1B in which the solar cell module 30 is secured to the seat member 20B is thereby constructed.

Furthermore, the nut member 80 can be made to slide in the lengthwise direction of the seat member 20B, thereby easily performing positional adjustment of the solar cell module 30 relative to the seat member 20B.

In the mounting structure 1 in the first embodiment, the member that abuts against the upper surface of the base portion 13 is the nut 50 (hexagonal nut) that is screwed together with the external thread portion 41. The diameter of the nut 50 is inevitably restricted by the diameter of the external thread portion 41. When the magnitude of a rotation moment acting on the base portion 13 in fastening between the bolt 40 and the nut 50 is tried to be reduced by the diameter of the nut 50, the external thread portion 41 needs to be reduced in diameter. By contrast, in the mounting structure 1B in the second embodiment, the member that abuts against the upper surface of the base portion 13 is the head 43b of the bolt 40B. It is sufficient that the size of head 43b is set so as not to cause the head 43b to pass through the insertion hole 14, thereby reducing the head 43b in diameter. For example, a bolt in which a hole or a groove fitting with a tool is recessed in a head like the bolt 40B having the head 43b with a hexagonal hole as illustrated in FIG. 9 can be made to have a smaller diameter than the nut that is screwed together with the external thread portion 41 having the same diameter. This provides an advantage that the magnitude of the rotation moment acting on the base portion 13 in fastening of the bolt 40B with the nut member 80 can be reduced by reducing the head 43b in diameter.

Although the nut member 80 that is inserted into the seat member 20B through the end opening thereof in the lengthwise direction has been described as an example, a nut member that is inserted thereinto through the long groove 24b of the seat member 20B from above can be used. For example, a nut member having a substantially quadrangular shape when seen from above can be inserted through the long groove 24b from above by setting the length of one pair of sides in the two pairs of sides of the nut member to be smaller than the width of the long groove 24b and setting the length of the other pair of sides to be larger than the width of the long groove 24b. Alternatively, even a nut member having the two pairs of sides both of which have larger lengths than the width of the long groove 24b can also be inserted through the long groove 24b from above by inclining the nut member as long as the nut member has a tapered surface the width of which is gradually reduced in the thickness direction.

In addition, although the nut member 80 is held in the seat member 20B by being installed on the rails 27 in the above description, even a seat member with no rails 27 enables the nut member to be held in the seat member. For example, a nut member having a substantially quadrangular shape when seen from above, which is formed by making only a pair of opposing corners thereof be curved, can be used. The nut member having this configuration is allowed to rotate in only one direction without interfering with the pair of standing wall portions and is held between the pair of standing wall portions by interference between the other pair of opposing corners and the pair of standing wall portions.

Next, a mounting structure in a third embodiment will be described. In this mounting structure, a solar cell module is secured to a seat member with a mounting tool and the solar cell module and the seat member are electrically conducted with each other through the mounting tool and a bolt. The mounting structure can be constructed by using the mounting tool that is same as that in the first embodiment or the second embodiment in the same manner except the configuration in which a projection is provided on the mounting tool made of metal and the projection is stuck into the frame body of the solar cell module. Even when a passive state film is formed on the surface of the frame body, the projection of the mounting tool sticks into the frame body to cause the frame body and the mounting tool to be conducted with each other. Moreover, each of the bolt upper abutment portion and the bolt lower abutment portion of the mounting tool abuts against the external thread portion of the bolt to cause the mounting tool and the seat member to be conducted with each other through the bolt.

In addition, the mounting tool has the projection sticking into the frame body, thereby increasing friction force on abutment surfaces between the frame body and the mounting tool. This increase also provides an advantage that the rotation moment acting on the mounting tool in fastening between the external thread portion of the bolt and the internal thread portion can be reduced.

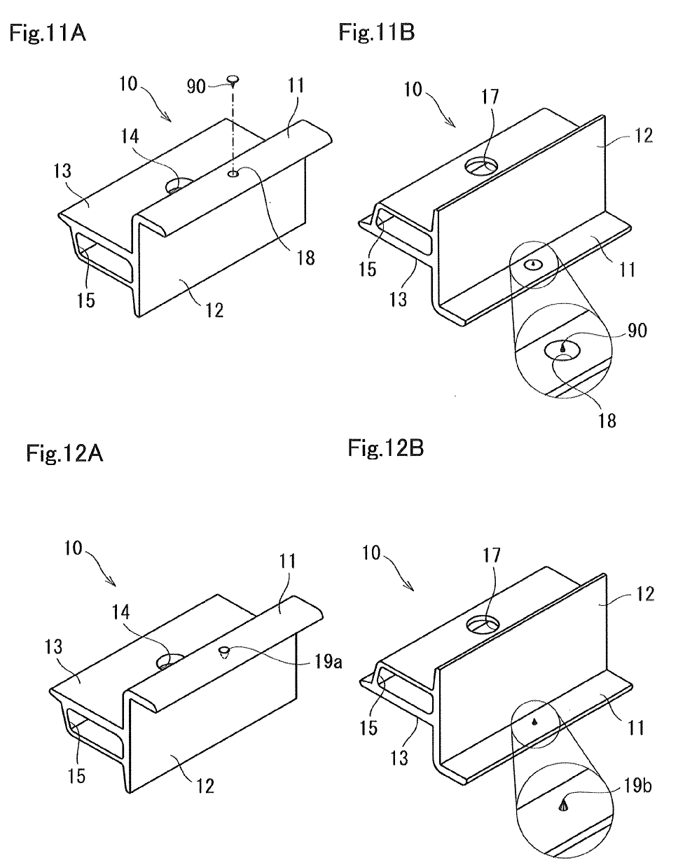

The projection of the mounting tool can be formed by making a hole 18 in a portion of the mounting tool 10, which abuts against the frame body 32, and securing a pin 90 made of metal into the hole 18 as illustrated in FIGS. 11A and 11B. Alternatively, the projection of the mounting tool can be formed by making a hole 19a which does not penetrate through the mounting tool 10 from a surface opposite to an abutment surface in a portion of the mounting tool 10, which abuts against the frame body 32, and causing a projection 19b to emerge on the opposite surface by plastic deformation of metal as illustrated in FIGS. 12A and 12B. This emboss processing can be performed simultaneously with punching processing of forming the insertion hole 14 in an extrusion molded body made of metal in a manufacturing process of the mounting tool 10.

Although the mounting tool 10 is illustrated in FIGS. 11A to 12B as the mounting tool on which the projection for conduction is provided, the projection can be provided on the mounting tool having another configuration as exemplified by the mounting tools 10A to 10H. Furthermore, although one projection is provided on the lower surface (back surface) of the upper surface abutment portion 11 in the drawings, a place at which the projection is provided may be on the upper surface abutment portion 11 or the side surface abutment portion 12 as long as the place abuts against the frame body 32. Furthermore, although one projection is provided on one mounting tool 10 in the drawings, a plurality of projections can be provided on one mounting tool.

Although the present invention has been described above using the preferred embodiments, the present invention is not limited by the above-described embodiments and various modifications and changes in design can be made in a range without departing from the scope of the present invention. It should be noted that hereinafter, the same reference numerals denote the same configurations and detail description thereof is omitted.

For example, in the above-described embodiments, the entire surface of the side surface abutment portion 12 of each of the mounting tools 10, 10A to 10H abuts against the side surface of the solar cell module 30. The present invention is not however limited thereto and the side surface abutment portion 12 can be configured to have an inclined portion or a bent portion to cause only a part thereof to abut against the side surface of the solar cell module 30.

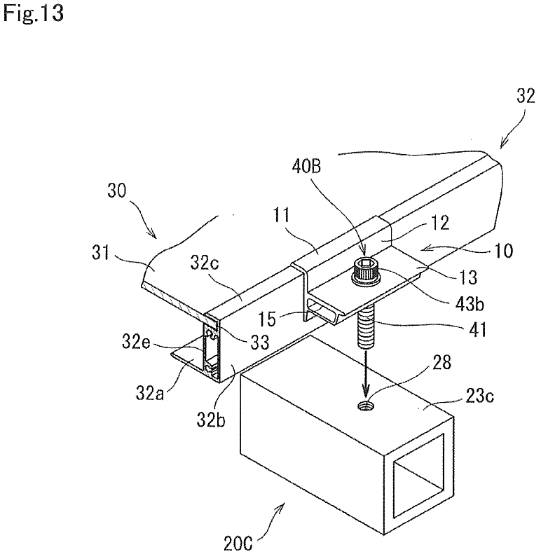

In the above description, as the second embodiment in which the head 43b of the bolt 40B abuts against the upper surface of the base portion 13 of the mounting tool 10, the internal thread portion with which the external thread portion 41 is screwed together is the nut member 80 that can slide in the lengthwise direction of the seat member 20B, as the example. The present invention is not however limited thereto and the internal thread portion with which the external thread portion 41 is screwed together can be an internal thread hole 28 formed in an upper surface portion 23c of a seat member 20C, as illustrated in FIG. 13.

What is claimed is:

1. A mounting structure for a solar cell module comprising:
a seat member that is secured to a mounting object;
a solar cell module that is installed on an upper surface of the seat member; and
a mounting tool that presses the solar cell module against the seat member by fastening a bolt which is parallel with a side surface of the solar cell module and an internal thread portion which is screwed together with an external thread portion of the bolt,
wherein the mounting tool includes:
a flat plate-like upper surface abutment portion that abuts against an upper surface of the solar cell module and one end side of which extends along one side of the solar cell module;
a side surface abutment portion that extends downward from the end side of the upper surface abutment portion so as to be shorter than a height of the side surface of the solar cell module and at least a part of which abuts against the side surface of the solar cell module;
a base portion that extends to an opposite side to the upper surface abutment portion side from a halfway position of the side surface abutment portion in an up-down direction;
an insertion hole that penetrates through the base portion in the up-down direction and through which the external thread portion is inserted;
a bolt upper abutment portion that is a portion of an inner circumferential surface of the insertion hole at an upper end side and abuts against a portion of the external thread portion, which is close to the upper surface abutment portion; and
a bolt lower abutment portion that abuts against a portion of the external thread portion, which is farther from the upper surface abutment portion, in a lower position relative to the bolt upper abutment portion, and
the bolt lower abutment portion is a portion of the inner circumferential surface of the insertion hole at a lower end side or a portion extending downward from an end portion of the base portion at an opposite side to an end portion at the side surface abutment portion side.

2. The mounting structure for the solar cell module according to claim 1,
wherein the seat member has a long groove that penetrates through an upper surface portion,
the external thread portion of the bolt, which extends upward through the long groove, is inserted through the insertion hole in a state in which a head of the bolt having such size that the head does not pass through the long groove is located inside the seat member, and
the internal thread portion is a nut that abuts against the base portion from above by being fastened with the external thread portion.

3. The mounting structure for the solar cell module according to claim 1,
wherein the seat member has a long groove that penetrates through an upper surface portion,
the external thread portion of the bolt, which extends downward through the insertion hole, is inserted through the long groove in a state in which a head of the bolt having such size that the head does not pass through the insertion hole is made to abut against the base portion from above, and
the internal thread portion is a nut member that is screwed together with the external thread portion in an internal thread hole and abuts against the upper surface portion from below by being fastened with the external thread portion in a state of being located inside the seat member.

4. A mounting tool comprising:
an upper surface abutment portion that has a flat plate-like shape and at least one end side of which is linear;
a side surface abutment portion that extends at a right angle from the linear end side;
a base portion that extends to an opposite side to the upper surface abutment portion side from a halfway position of the side surface abutment portion in an extension direction and has a larger thickness than thicknesses of the upper surface abutment portion and the side surface abutment portion;
an insertion hole that penetrates through the base portion in a thickness direction; and
a lightening hole that is orthogonal to the insertion hole and penetrates through the base portion in a direction which is parallel with the side surface abutment portion.
